(19) United States
(12) Patent Application Publication
(10) Pub. No.: US 2007/0068695 A1
(43) Pub. Date: Mar. 29, 2007

(54) ELECTRIC WIRE MATERIAL PROTECTIVE STRUCTURE

(75) Inventor: Yen Liu, Taipei (TW)

Correspondence Address: PAI PATENT & TRADEMARK LAW FIRM, 1001 FOURTH AVENUE, SUITE 3200, SEATTLE, WA, 98154, US

(73) Assignees: Yen Liu, Taipei (TW); HONG KAI LTD., Taipei (TW)

(21) Appl. No.: 11/162,917

(22) Filed: Sep. 28, 2005

(51) Int. Cl. H01R 9/05

(52) U.S. Cl. 174/74 R

(57) ABSTRACT

An electric wire material protective structure is disclosed, which includes a flexible plastic layer surrounding the core member of the electric wire material to be protected, and a hard plastic layer surrounding the core member of the electric wire material, wherein an end portion of the hard plastic layer covers an end portion of the flexible plastic layer, forming a tapered surface area between said hard plastic layer and said flexible plastic layer, and said tapered surface area extends in a direction along the length of the core member of the electric wire material.

### BACKGROUND OF THE INVENTION

1. Field of the Invention

The present invention relates to wire materials, and more particularly to a wire material protective structure for protecting an electric wire material against damage due to overbending.

2. Description of the Related Art

When bending an electric wire through an arch greater than 90°, the internal conductor(s) may break. In order to prevent breaking due to overbending, an electric wire has a protective structure near the end. FIGS. 1˜3 show an electric wire material protective structure according to the prior art. According to this design, the electric wire material protective structure comprises a plurality of annular ribs 5 extending around the periphery of the outer plastic shell of the electric wire material and spaced from one another along the length of the electric wire material at a gap. This design is still not satisfactory in function because, after a long use of the electric wire material, the outer plastic shell may break at the gap between two annular ribs 5 (see FIG. 3).

FIGS. 4˜6 show another design of electric wire material protective structure according to the prior art. According to this design, the electric wire material protective structure comprises a spiral rib 6 formed integral with and extending around the periphery of the outer plastic shell of the electric wire material. This structure of electric wire material protective structure is also not satisfactory in function. After a long use of the electric wire material, the outer plastic shell may break at the connection area between the outer plastic shell and the spiral rib 6 (see FIG. 6).

FIGS. 7˜9 show still another design of electric wire protective structure according to the prior art. According to this design, the electric wire material protective structure comprises an inner tube of flexible netting 7 and an outer tube of hard plastics 8. When bending the electric wire material, a shearing force will be produced at the bending angle between the outer tube of hard plastics 8 and the inner tube of flexible netting 7. This shearing force will also damage the internal conductor(s) of the electric wire material.

### SUMMARY OF THE INVENTION

The present invention has been accomplished under the circumstances in view. It is the main object of the present invention to provide an electric wire material protective structure, which prevents damage to the core member of the electric wire material when the electric wire material is bent through a great arc. To achieve this and other objects of the present invention, the electric wire material protective structure comprises a flexible plastic layer surrounding the core member of the electric wire material, and a hard plastic layer surrounding the core member of the electric wire material, wherein an end portion of the hard plastic layer covers an end portion of the flexible plastic layer, forming a tapered surface area between the hard plastic layer and the flexible plastic layer, and the tapered surface area extends in a direction along the core member of the electric wire material.

### BRIEF DESCRIPTION OF THE DRAWINGS

FIG. 1 is schematic drawing showing an electric wire material protective structure according to the prior art.

FIG. 2 is a sectional view of FIG. 1.

FIG. 3 corresponds to FIG. 1, showing a broken status of the electric wire material protective structure.

FIG. 4 is schematic drawing showing another design of electric wire material protective structure according to the prior art.

FIG. 5 is a sectional view of FIG. 4.

FIG. 6 corresponds to FIG. 4, showing a broken status of the electric wire material protective structure.

FIG. 7 is schematic drawing showing still another design of electric wire material protective structure according to the prior art.

FIG. 8 is a sectional view of FIG. 7.

FIG. 9 corresponds to FIG. 7, showing a broken status of the electric wire material protective structure.

FIG. 10 is a sectional view of an electric wire material protective structure formed on an electric wire material around the core member of the electric wire material according to the present invention.

FIG. 11 corresponds to FIG. 10, showing the electric wire material bent through an arc.

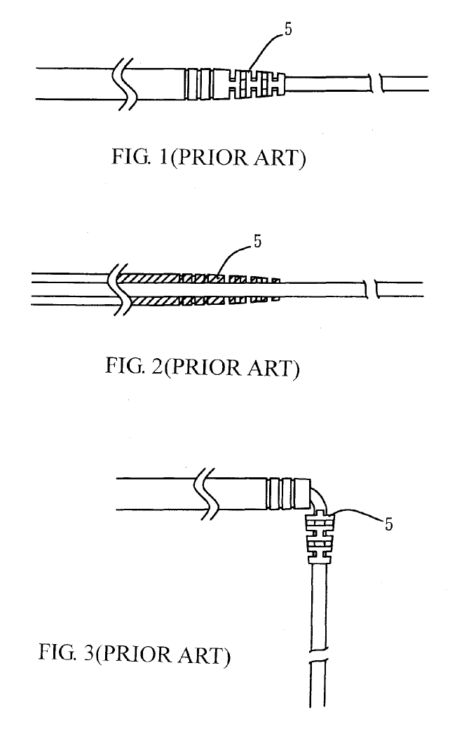

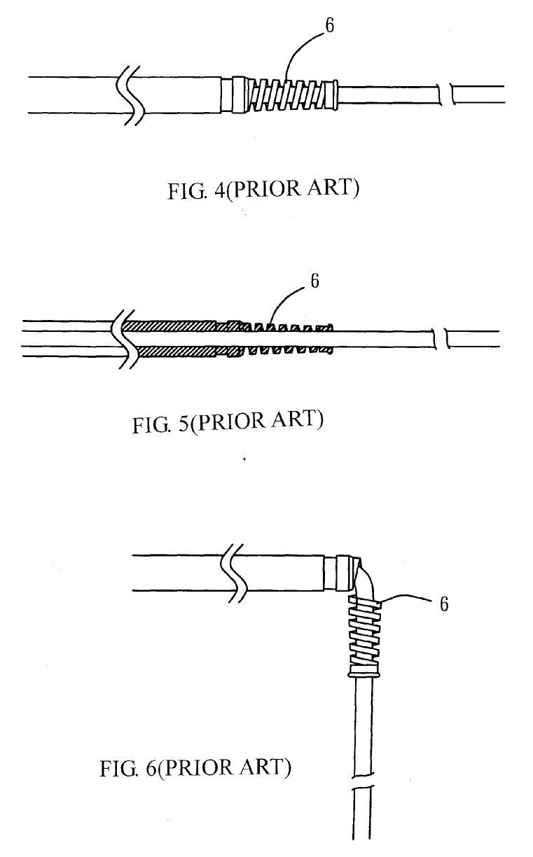

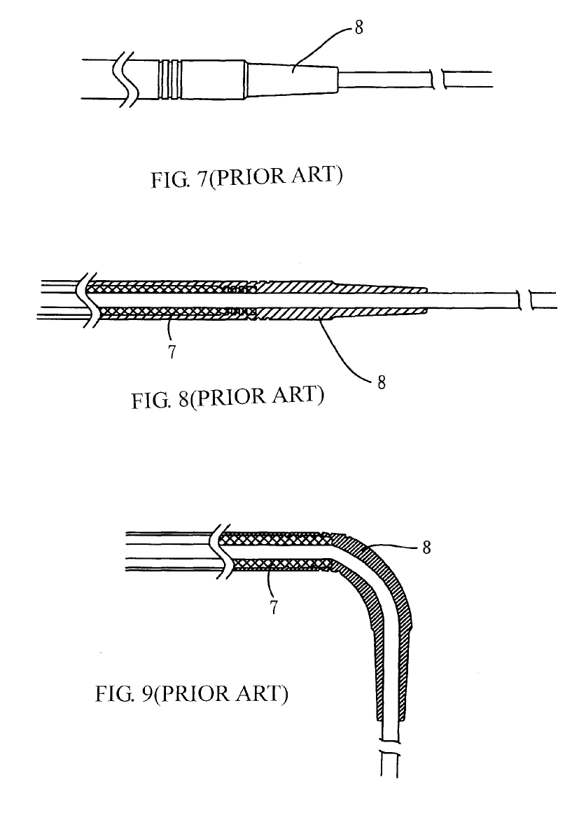

### DETAILED DESCRIPTION OF THE PREFERRED EMBODIMENT

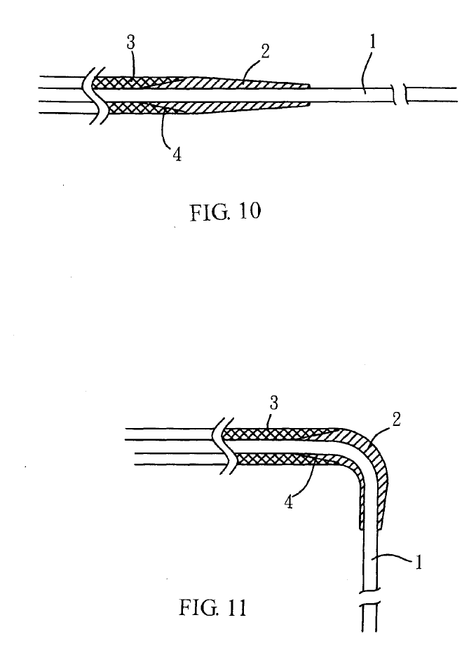

Referring to FIGS. 10 and 11, an electric wire material protective structure is shown for protecting a core member 1. The electric wire material protective structure comprises a flexible plastic layer 2 surrounding the core member 1, and a hard plastic layer 3 surrounding the core member 1, wherein an end portion of the hard plastic layer 3 covers an end portion of the flexible plastic layer 2, forming a tapered surface area 4 between the hard plastic layer 3 and the flexible plastic layer 2, and the tapered surface area extends in a direction along the core member 1. The hard plastic layer 3 and the flexible plastic layer 2 respectively extend from the tapered surface area 4 in opposite directions for a predetermined distance and respectively cover the periphery of the core member 1.

When bent the electric wire material through an arc over 90°, the hard plastic layer 3 supports the core member 1 in the tapered sloping surface area 4 against damage, and the curved portion of the core member 1 will be within the area surrounded by the flexible plastic layer 2. This design prevents the formation of a sharp angle at the electric wire material when the electric wire material is bent through a great arch. Therefore, bending the electric wire material does not cause the core member 1 to break.

A prototype of electric wire material protective structure has been constructed with the features of FIGS. 10 and 11. The electric wire material protective structure functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An electric wire material protective structure for an electric wire material for protecting the core member of the electric wire material, the electric wire material protective structure comprising
a flexible plastic layer surrounding the core member of said electric wire material, and
a hard plastic layer surrounding the core member of said electric wire material,
wherein an end portion of said hard plastic layer covers an end portion of said flexible plastic layer, forming a tapered surface area between said hard plastic layer and said flexible plastic layer, and
said tapered surface area extends in a direction along the core member of said electric wire material.
